(19) United States
(12) Patent Application Publication
(10) Pub. No.: US 2023/0138175 A1
(43) Pub. Date: May 4, 2023

(54) BLIND FASTENER

(71) Applicant: Howmet Aerospace Inc., Pittsburgh, PA (US)

(72) Inventor: Luke L. Haylock, Culver City, CA (US)

(21) Appl. No.: 17/515,108

(22) Filed: Oct. 29, 2021

(51) Int. Cl. F16B 19/10

(52) U.S. Cl. CPC F16B 19/1063

(57) ABSTRACT

A fastener includes a sleeve having a tubular portion including a first end and a second end; a head located at the first end; a deformable portion located at the second end; and a core pin having a first end and a second end. The core pin has an elongated shank portion between the first end of the core pin and the second end of the core pin including a threaded portion proximate the second end of the core pin and a head at the first end of the core pin. The sleeve is configured to receive the core pin. The fastener is configured to secure a plurality of workpieces to one another. The deformable portion is configured deflect in response to compression of the deformable portion by the head of the core pin, to form a flared connection that engages a surface of one of the plurality of workpieces.

### FIELD

This disclosure relates generally to fasteners. More particularly, this disclosure relates to fasteners such as blind fasteners for securing a plurality of workpieces together.

### BACKGROUND

Blind fasteners are commonly used to secure a plurality of workpieces together when it is difficult or impossible to access a blind side of one of the workpieces.

### SUMMARY

In some embodiments, a fastener includes a sleeve having a tubular portion including a first end and a second end opposite the first end. In some embodiments, the fastener includes a head located at the first end. In some embodiments, the fastener includes a deformable portion located at the second end. In some embodiments, the fastener includes a core pin having a first end and a second end opposite the first end of the core pin. In some embodiments, the core pin has an elongated shank portion between the first end of the core pin and the second end of the core pin. In some embodiments, the elongated shank portion includes a threaded portion proximate the second end of the core pin and a head at the first end of the core pin. In some embodiments, the sleeve is configured to receive the core pin. In some embodiments, the fastener is configured to secure a plurality of workpieces to one another. In some embodiments, the deformable portion of the sleeve is configured to be deflected in response to compression of the deformable portion by the head of the core pin, such that the deformable portion forms a flared connection that engages a surface of one of the plurality of workpieces.

In other embodiments of any of the foregoing fastener embodiments, the head of the sleeve of the fastener may additionally and/or alternatively include at least one recess.

In other embodiments of any of the foregoing fastener embodiments, the threaded portion of the core pin of the fastener may additionally and/or alternatively include thread-forming external threads.

In other embodiments of any of the foregoing fastener embodiments, the sleeve of the fastener may additionally and/or alternatively include an internal wall. In other embodiments of any of the foregoing fastener embodiments, the thread-forming external threads of the core pin may additionally and/or alternatively be configured to form corresponding internal threads in the internal wall of the sleeve.

In other embodiments of any of the foregoing fastener embodiments, a diameter of the head of the core pin of the fastener may additionally and/or alternatively be greater than an outer diameter of the sleeve.

In other embodiments of any of the foregoing fastener embodiments, the head of the core pin of the fastener may additionally and/or alternatively include a splined head.

In other embodiments of any of the foregoing fastener embodiments, the core pin of the fastener may additionally and/or alternatively include a drive portion configured to be engaged by a fastener installation tool.

In other embodiments of any of the foregoing fastener embodiments, the core pin of the fastener may additionally and/or alternatively include a breakneck groove located intermediate the drive portion and the threaded portion, and wherein the drive portion is configured to be separated from the elongated shank portion at the breakneck groove.

In other embodiments of any of the foregoing fastener embodiments, a diameter of the flared connection of the fastener may additionally and/or alternatively may be greater than 1.1 to 2 times an outer diameter of the tubular portion of the sleeve.

In other embodiments of any of the foregoing fastener embodiments, the core pin of the fastener may additionally and/or alternatively be composed of a first material and the sleeve be composed of a second material. In other embodiments of any of the foregoing fastener embodiments, the first material is harder than the second material.

In other embodiments of any of the foregoing fastener embodiments, the core pin of the fastener may additionally and/or alternatively be composed of stainless steel.

In other embodiments of any of the foregoing fastener embodiments, the core pin of the fastener may additionally and/or alternatively be composed of alloy steel.

In other embodiments of any of the foregoing fastener embodiments, the sleeve of the fastener may additionally and/or alternatively be composed of aluminum alloy.

In other embodiments of any of the foregoing fastener embodiments, the sleeve of the fastener may additionally and/or alternatively be composed of brass.

In other embodiments of any of the foregoing fastener embodiments, the sleeve of the fastener may additionally and/or alternatively be composed of copper.

In other embodiments of any of the foregoing fastener embodiments, the fastener may additionally and/or alternatively include the surface of the one of the plurality of workpieces being a blind side surface.

In other embodiments of any of the foregoing fastener embodiments, the deformable portion of the fastener may additionally and/or alternatively include a ramped portion.

In other embodiments of any of the foregoing fastener embodiments, the ramped portion of the fastener may additionally and/or alternatively include a first thickness located at the first end of the sleeve and a second thickness proximate to the second end of the sleeve. In some embodiments, the first thickness is greater than the second thickness.

### BRIEF DESCRIPTION OF THE DRAWINGS

References are made to the accompanying drawings that form a part of this disclosure and that illustrate embodiments in which the invention described in this Specification can be practiced.

FIG. 1 is a side elevational view of a partially cross-sectioned blind fastener, according to some embodiments.

FIG. 2 is an enlarged view of detail A shown in FIG. 1, according to some embodiments.

FIG. 3 is an enlarged view of detail B shown in FIG. 1, according to some embodiments.

FIG. 4 is a side elevational view of the blind fastener shown in FIG. 1 inserted into workpieces, according to some embodiments.

FIG. 5 is an enlarged view of detail C shown in FIG. 4, according to some embodiments.

FIG. 6 is an enlarged view of detail D shown in FIG. 4, according to some embodiments.

FIG. 7 is a side elevational view of the blind fastener shown in FIG. 1 fully installed within the workpieces, according to some embodiments.

FIG. 8 is an enlarged view of detail E shown in FIG. 7, according to some embodiments.

FIG. 9 is an enlarged view of detail F shown in FIG. 7, according to some embodiments.

Like reference numbers represent the same or similar parts throughout.

### DETAILED DESCRIPTION

In some embodiments, a blind fastener includes a deformable end capable of securing workpieces together, where the workpieces include a blindside workpiece in which a tool is not accessible or in which the workpiece is not visible. In some embodiments, the blind fastener is a pull-type blind fastener in which an installation force is directed toward a blindside of the blindside workpiece.

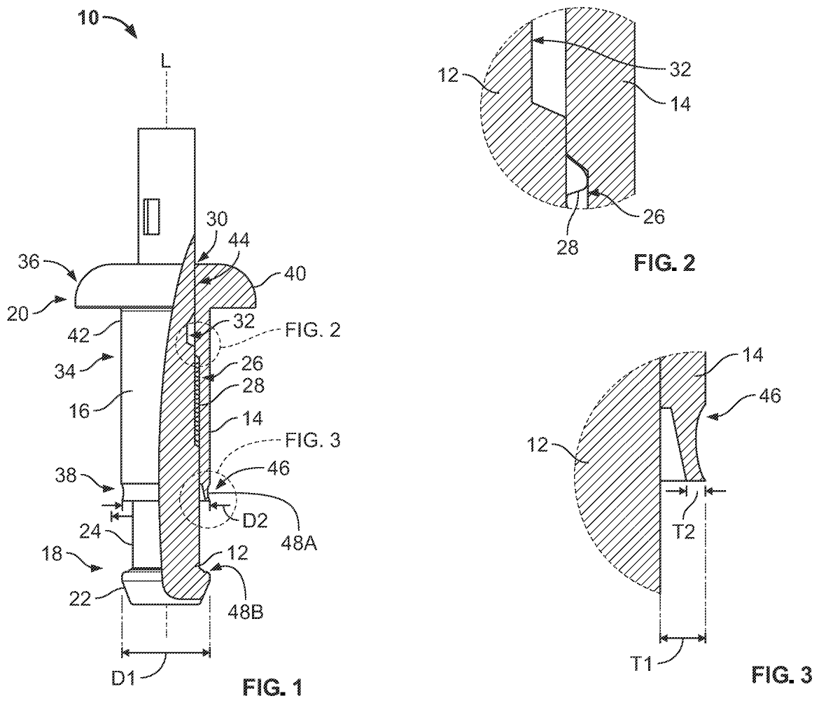

Referring to FIGS. 1 through 3, in some embodiments, a fastener 10 includes a core pin 12 and a sleeve 14 configured to receive the core pin 12. In some embodiments, the core pin 12 is disposed within the sleeve 14. In the some embodiments, the fastener 10 shown in FIGS. 1 through 3 can be referred to as being in a pre-installation state.

In some embodiments, the core pin 12 includes an elongated shank portion 16 extending along a longitudinal axis L, the elongated shank portion 16 having a first end 18 and a second end 20 opposite the first end 18. In some embodiments, the core pin 12 terminates in a head 22 at the first end 18. In embodiments, the head 22 is an enlarged head. In some embodiments, the head 22 may include other shapes and sizes beyond that shown in FIG. 1. In some embodiments, the elongated shank portion 16 includes a substantially smooth cylindrical portion 24 adjacent to the first end 18. In some embodiments, the elongated shank portion 16 includes a threaded portion 26 intermediate the first end 18 and the second end 20. In some embodiments, the threaded portion 26 includes threads 28. In some embodiments, threads 28 are thread-forming threads. In some embodiments, the elongated shank portion 16 includes a drive portion 30. In some embodiments, a breakneck groove 32 is located between the threaded portion 26 of the elongated shank portion 16 and the drive portion 30. In some embodiments, the head 22 has a diameter D1. In some embodiments, the core pin 12 includes a splined head.

In some embodiments, the core pin 12 is composed of steel. In some embodiments, the core pin 12 is composed of stainless steel. In some embodiments, the core pin 12 is composed of 300 series stainless steel. In some embodiments, the core pin 12 is composed of alloy steel. In some embodiments, the core pin 12 is composed of a corrosion resistant material. In some embodiments, the core pin 12 is composed of titanium alloys. In some embodiments, the core pin 12 is composed of nickel alloys.

In some embodiments, the sleeve 14 includes a tubular portion 34 having a first end 36 and a second end 38 opposite the first end 36. In some embodiments, the sleeve 14 terminates in a head 40 at the first end 36. In some embodiments, the head 40 is an enlarged head. In some embodiments, the head 40 protrudes from the accessible surface of the workpieces when the fastener 10 is installed therein. In some embodiments, the head 40 is flush with the accessible surface of the workpieces when the fastener 10 is installed therein. In some embodiments, the head 40 is a countersunk head. In some embodiments, the head 40 includes one or more recesses to prevent spinning of the sleeve 14 during rotation of the core pin 12 when installing the fastener 10.

In some embodiments, the tubular portion 34 includes an internal smooth wall 42. In some embodiments, the head 40 includes an internal smooth wall 44. In some embodiments, the internal smooth wall 42 of the tubular portion 34 is aligned or integral with the internal smooth wall 44 of the head 40. In some embodiments, the internal smooth wall 42 of the tubular portion 34 and the internal smooth wall 44 of the head 40 are sized and shaped to receive the elongated shank portion 16 of the core pin 12. In some embodiments, the threaded portion 26 of the core pin 12 is located within the internal smooth wall 42 of the tubular portion 34 of the sleeve 14 adjacent to the head 40 of the sleeve 14 when the fastener 10 is in its preinstalled position. In some embodiments, the internal smooth wall 44 of the head 40 is configured to receive the threaded portion 26 of the core pin 12, which will be described hereinafter.

In some embodiments, the sleeve 14 includes a deformable portion 46 located at the second end 38 of the tubular portion 34. In some embodiments, the deformable portion 46 includes a ramped portion 48A that is configured as later described to engage a ramped portion 48B on the head 22 of the pin 12. The ramped portion 48A has a variable thickness. In some embodiments, the variable thickness can be a decreasing thickness so that a thickness T2 of the deformable portion 46 at the second end 38 is smaller than a thickness T1 of the deformable portion 46 closer to the first end 36. In some embodiments, the deformable portion 46 has a diameter D2. In some embodiments, the diameter D2 is smaller than the diameter D1 of the head 22.

In some embodiments, the sleeve 14 is composed of copper. In some embodiments, the sleeve 14 is composed of brass. In some embodiments, the sleeve 14 is composed of an aluminum alloy. In some embodiments, the aluminum alloy is a 6066 aluminum alloy. In some embodiments, the sleeve 14 is composed of stainless steel. In some embodiments, the sleeve 14 is composed of 300 series stainless steel.

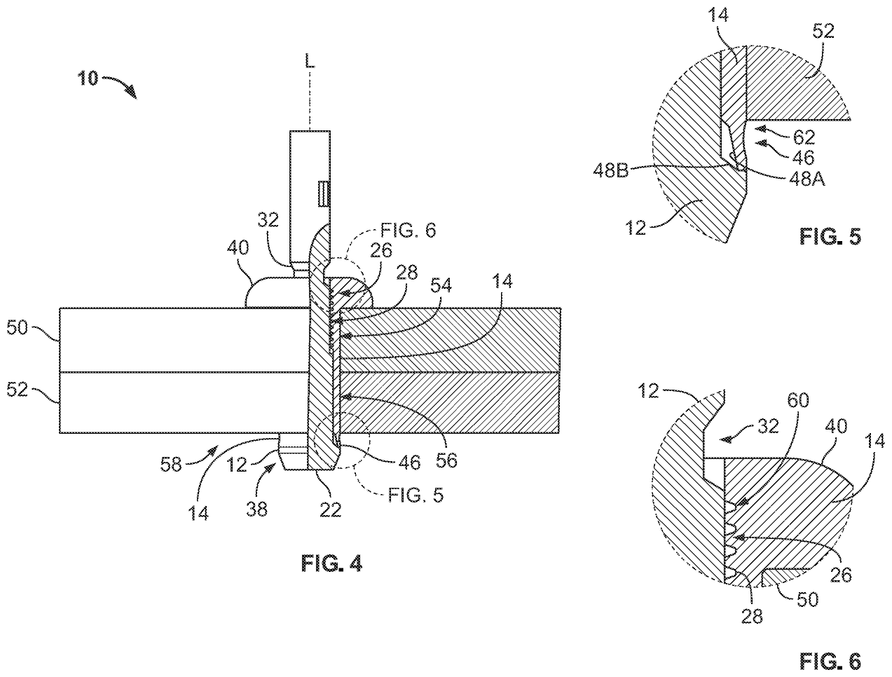

Referring to FIGS. 4 through 6, in some embodiments, the fastener 10 is configured to secure a plurality of workpieces 50, 52 to one another, and is configured to be installed within aligned holes 54, 56 formed within the workpieces 50, 52, respectively. In some embodiments, each of the holes 54, 56 has an inner diameter that is sized to accommodate the fastener 10. For simplicity of this Specification, features of the fastener 10 already discussed will not be described in additional detail unless specifically referenced.

In some embodiments, with reference to FIGS. 4 through 6, the fastener 10 is partially installed within the workpieces 50, 52 In some embodiments, the workpiece 52 includes a blind side 58. In some embodiments, the blind side 58 is difficult or impossible to access by a user with a fastener installation tool or otherwise or is difficult or impossible to view by the user. In some embodiments, the head 22 of the core pin 12 is adjacent the second end 38 of the sleeve 14. In some embodiments, at least a portion of the head 22 abuts the second end 38 of the sleeve 14. In some embodiments, the threaded portion 26 is positioned closer to the head 40 and plastically deforms the head 40 so that internal threads 60 of the sleeve 14 are formed by threads 28. In some embodiments, the threads 28 of the core pin 12 threadedly engage the internal threads of the sleeve 14 to secure the core pin 12 to the sleeve 14.

In some embodiments, to transition from the pre-installation state to the partially installed state, an installation tool can be used to engage the drive portion 30 and to rotate the core pin 12 relative to the sleeve 14, causing engagement of the threaded portion 26 and the internal threads 28. The engagement of the threaded portion 26 and the internal threads 28 forces the sleeve 14 to buckle and move toward the blindside workpiece 52 to form a flared connection 62 at the deformable portion 46. The formation of the flared connection 62 secures the workpiece 52 and the workpiece 50 together. The fastener 10 is unable to move in either direction (e.g., toward the workpiece 50 or away from the workpiece 50) due to the presence of the head 40 on the workpiece 50 and the flared connection 62 on the workpiece 52.

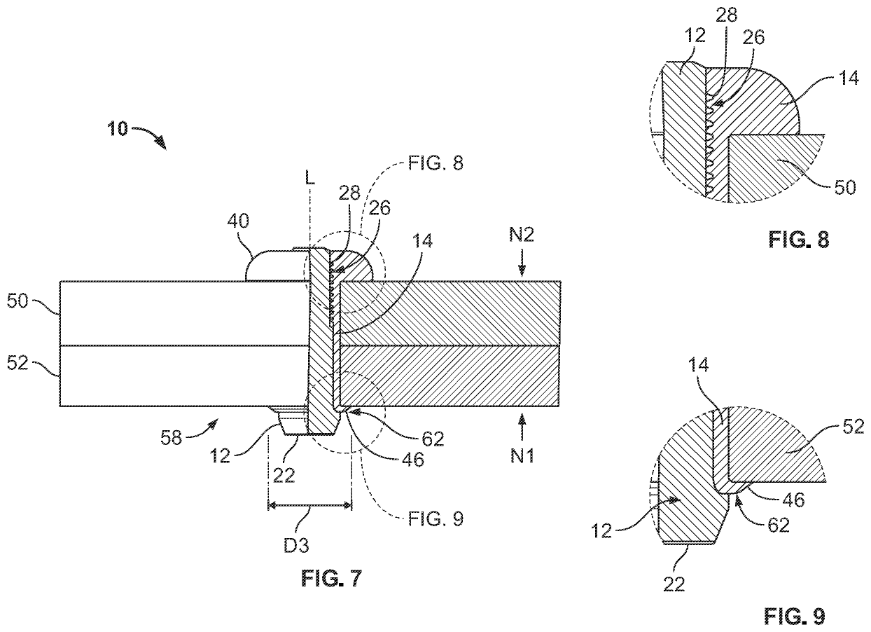

Referring to FIGS. 7 through 9, in some embodiments, the fastener 10 is configured to secure the workpiece 50 to the workpiece 52 when the fastener 10 is in an installed position. For simplicity of this Specification, features of the fastener 10 already discussed will not be described in additional detail unless specifically referenced.

In some embodiments, when the fastener 10 is in its installed position, the deformable portion 46 receives a compression force from the head 22 and the deformable portion 46 is resultingly deflected and deformed by the ramped portion 48B of the head 22 to initiate formation of the flared connection 62. In some embodiments, the flared connection 62 causes the deformable portion 46 to apply a force in a normal direction N1 to the workpiece 52. In some embodiments, the head 40 applies a force in a normal direction N2 to the workpiece 50. In some embodiments, the workpiece 50 and the workpiece 52 are secured to each other. In some embodiments, the drive portion 30 breaks and is removed from the fastener 10 at the breakneck groove 32. In some embodiments, to contribute to the deformation of the deformable portion 46, the core pin 12 and more particularly the head 22 are made of a harder material than the sleeve 14 and more particularly the deformable portion 46.

In some embodiments, a size of the deformable portion 46 is selected so that a resulting diameter D3 of the flared connection 62 is greater than an outer diameter D2 of the sleeve 14. In some embodiments, the diameter D3 is 1.1 to 1.7 times greater than the outer diameter D2. In some embodiments, the diameter D3 is 1.5 times greater than the outer diameter D2.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A fastener, comprising:
a sleeve having:
a tubular portion including a first end and a second end opposite the first end,
a head located at the first end, and
a deformable portion located at the second end; and
a core pin having:
a first end and a second end opposite the first end of the core pin,
an elongated shank portion between the first end of the core pin and the second end of the core pin,
wherein the elongated shank portion includes a threaded portion proximate the second end of the core pin and a head at the first end of the core pin,
wherein the sleeve is configured to receive the core pin, and
wherein the fastener is configured to secure a plurality of workpieces to one another,
wherein the deformable portion of the sleeve is configured to be deflected in response to compression of the deformable portion by the head of the core pin, such that the deformable portion forms a flared connection that engages a surface of one of the plurality of workpieces.

2. The fastener of claim 1, wherein the head of the sleeve includes at least one recess.

3. The fastener of claim 1, wherein the threaded portion of the core pin includes thread-forming external threads.

4. The fastener of claim 3, wherein the sleeve includes an internal wall, and wherein the thread-forming external threads of the core pin are configured to form corresponding internal threads in the internal wall of the sleeve.

5. The fastener of claim 1, wherein a diameter of the head of the core pin is greater than an outer diameter of the sleeve.

6. The fastener of claim 1, wherein the head of the core pin includes a splined head.

7. The fastener of claim 1, wherein the core pin includes a drive portion configured to be engaged by a fastener installation tool.

8. The fastener of claim 7, wherein the core pin includes a breakneck groove located intermediate the drive portion and the threaded portion, and wherein the drive portion is configured to be separated from the elongated shank portion at the breakneck groove.

9. The fastener of claim 1, wherein a diameter of the flared connection is greater than 1.1 to 2 times an outer diameter of the tubular portion of the sleeve.

10. The fastener of claim 1, wherein the core pin is composed of a first material and the sleeve is composed of a second material, and wherein the first material is harder than the second material.

11. The fastener of claim 10, wherein the core pin is composed of stainless steel.

12. The fastener of claim 10, wherein the core pin is composed of alloy steel.

13. The fastener of claim 10, wherein the sleeve is composed of aluminum alloy.

14. The fastener of claim 10, wherein the sleeve is composed of brass.

15. The fastener of claim 10, wherein the sleeve is composed of copper.

16. The fastener of claim 1, wherein the surface of the one of the plurality of workpieces is a blind side surface.

17. The fastener of claim 1, wherein the deformable portion includes a ramped portion.

18. The fastener of claim 17, wherein the ramped portion includes a first thickness located at the first end of the sleeve and a second thickness proximate to the second end of the sleeve, wherein the first thickness is greater than the second thickness.
